(19) United States
(12) Patent Application Publication
(10) Pub. No.: US 2002/0144420 A1
(43) Pub. Date: Oct. 10, 2002

(54) Angle measurement tool

(76) Inventor: Juan A. Mora, Carson, CA (US)

Correspondence Address: Roy A. Ekstrand, Ste. 150, 3158 Redhill Ave., Costa Mesa, CA, 92626, US

(21) Appl. No.: 09/827,879

(22) Filed: Apr. 6, 2001

(51) Int. Cl. G01B 3/56

(52) U.S. Cl. 33/536; 33/370

(57) ABSTRACT

An angle measurement tool includes a frame supporting a rectangular plate upon which a calculator is positioned. The frame further supports a pivotal sine bar having a bubble assembly supported thereon. The angle measurement tool provides angle measurement and setting by positioning the lower edge of the plate upon the surface of interest and pivoting the sine bar until the bubble assembly indicates a horizontal attitude of the sine bar. The calculator is a dedicated calculator providing basic functions of finding an angle given its opposite side measurement or finding an opposite side given the angle. In an alternate embodiment, a plate defines a reference edge and a plurality of angles and receives a removable bubble assembly which is utilized for measuring standard angles.

### FIELD OF THE INVENTION

This invention relates generally to precision machining and fabrication and processes and particularly to measurement and establishment of precision angles in forming a machined or precision manufactured item.

### BACKGROUND OF THE INVENTION

In a machine or tool shop operation there often arises a need for machining or otherwise forming a surface or facet upon a to-be-fabricated part, usually referred to as a “work piece” which defines a precise angular relationship to another surface. Machines such as milling machines or precision grinding machines provide a bed or table surface which is horizontal and over which or upon which the grinding or cutting tool is moved.

Basically, the horizontal surface provided by the machine bed or table is established by the precise construction of the machine itself together with the solid and secure support of the machine upon the shop floor. The cutting tool of a milling machine or the wheel carriage of a precision grinding machine for example, move over and across the table or bed in a highly precise travel path which is parallel to the surface of the bed or table. It will be noted that while precision milling machines and precision grinding machines form a convenient example of the use of the present invention apparatus set forth below, the present invention applies equally well to virtually any angular measurement or determination where a high degree of precision is required.

Because of the above fabrication of machines, such as milling machines and precision grinding machines, the forming of a surface upon a work piece which is generally parallel to a given surface is readily accomplished by orienting one surface upon or parallel to the table or bed and thereafter machining or grinding the desired parallel surface. While a work piece may be rested and secured directly upon the table or bed of a machine, more often, the work piece is held within a suitable vice or clamp upon the table or bed.

Forming a surface upon a work piece which is disposed at a given angle relevant to another surface upon the work piece typically involves orienting the work piece such that the reference surface is at the desired angle relative to the horizontal reference surface of the machine, table or bed. Thereafter, the milling or surface grinding of the working surface of the work piece is formed at the desired angle by the operation of the milling machine tool or grinding machine wheel.

In many operations in a typical machine or tool shop, the opposite process to that described above is required. That is to say, the operator often needs to accurately measure the existing angle between two surfaces on the work piece.

For the most part, either process (forming a surface at a given angle to another surface or precisely measuring an existing angle) is often difficult in a typical machine or tool shop. Devices such as protractors are often employed. However, their use usually lacks the required precision and is sometimes difficult in its implementation. Certain angles may be precisely established using sineblocks, which derive their name from their use of the trigonometric sine relationships of angles. Such sineblocks may used for a limited number of “special angles” (for example, thirty degrees, forty-five degrees or sixty degrees). However, the use of sineblocks for angular measurement or setting is not practical for a broad range of angles.

There arises therefore, a continuing need in the art for ever more improved apparatus for measuring and establishing a precise angle between surfaces of a precision work piece.

### SUMMARY OF THE INVENTION

Accordingly, it is a general object of the present invention to provide an improved angle measurement tool. It is a more particular object of the present invention to provide an improved angle measurement tool which readily and precisely facilitates establishing a predetermined angle with great precision and/or measuring an existing angle with great precision. It is a further object of the present invention to provide an improved angle measurement tool which may be easily utilized within the environment of a machine or tool shop.

In accordance with the present invention there is provided an angle measurement tool comprising: a frame; a sine bar having first and second ends; a pivot pivotally joining the one end of the sine bar to the frame, the sine bar pivotable with respect to the frame; a plate secured to the frame and defining a front surface and a lower edge; and a bubble assembly secured to the sine bar having a liquid and glass bubble level indicator.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of an angle measurement tool constructed in accordance with the present invention;

FIG. 2 sets forth a side elevation view of the present invention angle measurement tool;

FIG. 3 sets forth a top view of the present invention angle measurement tool;

FIG. 4 sets forth a front view of the present invention angle measurement tool in a typical use;

FIG. 5 sets forth a perspective assembly view of an alternate embodiment of the present invention angle measurement tool;

FIG. 6 sets forth a front view of the alternate embodiment of FIG. 5 in a typical use;

FIG. 7 sets forth a front view of a still further alternate embodiment of the present invention angle measurement tool.

### DESCRIPTION OF THE PREFERRED EMBODIMENTS

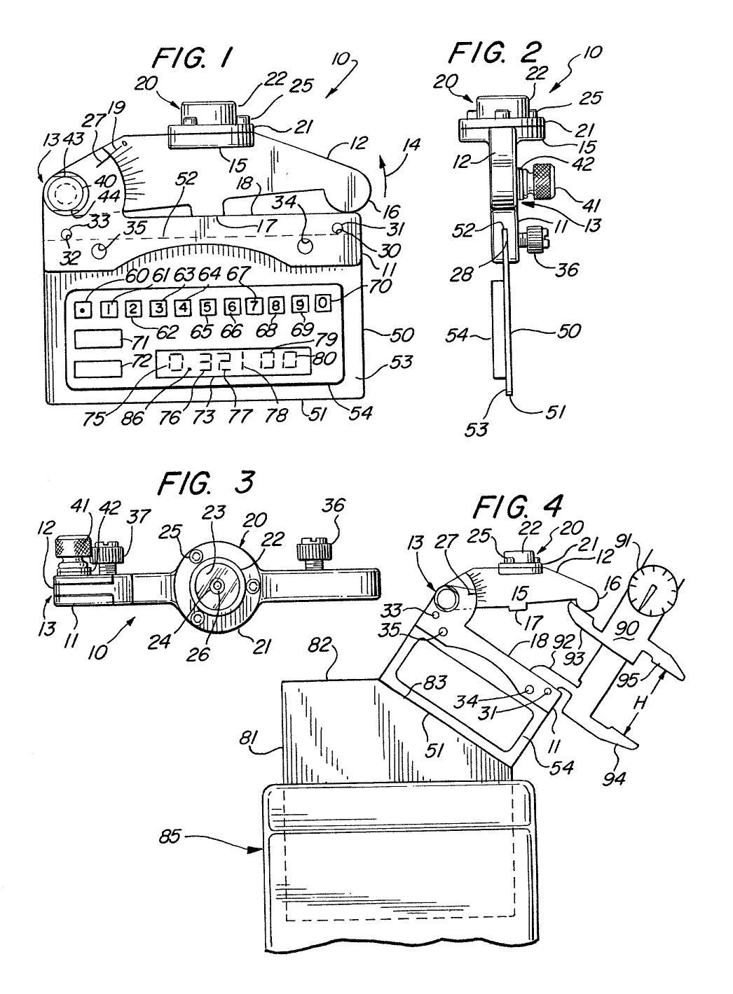

FIG. 1 sets forth a front view of an angle measurement tool constructed in accordance with the present invention and generally referenced by numeral 10. Angle measurement tool 10 includes a frame 11 having an upper edge 18 and defining a pair of apertures 34 and 35. Frame 11 further defines a second pair of apertures 30 and 32. Aperture 30 receives a cylindrical reference pin 31 while aperture 32 receives a cylindrical reference pin 33. As is better seen in FIG. 2, frame 11 further defines an elongated slot 28 extending the entire width of frame 11.

Tool 10 further includes a sine bar 12 having a cylindrical end 16 and a travel limit stop 17. Sine bar 12 further includes a flange 15 which receives and supports a bubble assembly 20. Bubble assembly 20 includes a plate 21 resting upon flange 15 and secured thereto by a plurality of fasteners 25. Bubble assembly 20 further includes a cylindrical riser 22 which, as is better seen in FIG. 3, supports a sight glass 23 having a reference mark 24 formed thereon. In accordance with conventional fabrication techniques, bubble assembly 20 supports a quantity of liquid (not shown) beneath sight glass 23 and a captivated air bubble 26.

Returning to FIG. 1, sine bar 12 is pivotally secured to frame 11 by a threaded fastener 40 together with a threaded screw 41 and spring washers 42 (screw 41 and spring washers 42 better seen in FIG. 2) the attachment provided by pivot 13 utilizes threaded fastener 40 in threaded engagement with screw 41. Toward this end, threaded fastener 40 defines a pair of flat edges 43 and 44 which are captivated within raised portions formed upon frame 11. This prevents threaded fastener 40 from moving and allows the pivoting resistance of sine bar 12 to be adjusted by turning screw 41 to compress spring washers 42 (seen in FIG. 2).

Sine bar 12 further supports a radial mark angle defining scale 19 which cooperates with a reference mark or index mark 27 formed upon frame 11.

Angle measurement tool 10 further includes a rectangular plate 50 having a lower edge 51 and an upper edge 52 which is parallel to lower edge 51. Upper edge 52 of plate 50 is received within slot 28 (seen in FIG. 2) and is positioned against reference pins 31 and 33. A pair of fasteners 36 and 37 (seen in FIG. 3) are threadably received within apertures 34 and 35 and provide for secure attachment of plate 50 within frame 11 against reference pins 31 and 33. In this manner, edge 51 is parallel to edge 18 of frame 11.

In further accordance with the present invention, plate 50 defines a front surface 53 upon which a calculator 54 is supported. Calculator 54 is fabricated in accordance with conventional fabrication techniques and provides a microprocessor based calculator system (not shown) which facilitates calculation of angles and sines of angles of the manner set forth below. Calculator 54 is a highly specialized calculator which is dedicated to performing sine calculations in accordance with standard trigonometric laws. Thus, calculator 54 includes a plurality of input buttons and a numeric display 73. In accordance with the preferred fabrication of the present invention, display 73 utilizes a plurality of liquid crystal seven segment display elements such as segments 75, 76, 77, 78, 79 and 80. Display 73 further accommodates a decimal point indicator 86.

Input key 60 provides a decimal point input while keys 61 through 70 provide numeric inputs for the numbers 1 through 0 respectively. In addition, calculator 54 includes a command input button 71 which implements a “find the angle” function together with command input button 72 which provides a “set H” function.

In operation, angle measurement tool 10 is operated by pivoting sine bar 12 about pivot 13 in the direction indicated by arrow 14. The pivotal movement of sine bar 12 may be roughly set to a desired angle by employing the cooperation of scale 19 and reference mark 27. However, the precise determination of the angle between sine bar 12 and frame 11 (and thereby edge 51) is determined in a more precise manner described below. Suffice it to note here, that a precise measurement of the distance between end 16 and edge 18 of frame 11 at any given position of sine bar 12 provides the “H” input for calculation of the precise angle between sine bar 12 and frame 11 using the trigonometric sine angle relationship. For purposes of convenience, tool 10 is preferably fabricated such that a convenient distance is provided between the center axis of pivot 13 which defines the pivotal movement of sine bar 12 and the center of circular end 16. In accordance with this preference, tool 10 shown in FIG. 1 is fabricated to find a distance between the center of pivot 13 and the center of end 16 which equals three inches. However, other distances may be used without departing from the spirit and scope of the present invention.

The operation of angle measurement tool 10 is set forth below in conjunction with FIG. 4 in greater detail. However, suffice it to note here, that tool 10 may be used to either establish a given angle with great precision or alternatively to measure an unknown angle with equal precision. When establishing a desired angle, the user activates the appropriate ones of keys 60 through 70 to input the desired angle. Thereafter, the user activates command key 72 to cause calculator 54 to compute the H distance (the distance between edge 18 and end 16 of sine bar 12 as sine bar 12 is pivoted). The correct value for H appears within display 73. The user then simply employs a precision measuring instrument such as a caliper or the like (see for example FIG. 4) to set the pivotal position of sine bar 12. Once this pivotal position has been set equal to the computed H value, the angular relationship between sine bar 12 and edge 51 of plate 50 has been established. Conversely, in the event tool 10 is being utilized to determine an unknown angle, edge 51 is placed against the angled surface in the manner shown in FIG. 4 and sine bar 12 is pivoted in the direction indicated by arrow 14 until bubble assembly unit 20 shows a horizontal position for bubble assembly unit 20. At this point, the user then measures the distance between edge 18 and end 16 of sine bar 12 to produce a distance corresponding to H. The user then employs numeric input keys 60 through 70 to input the measurement for H thus derived, into calculator 54. Once this is accomplished, the user activates command key 71 causing calculator 54 to employ a simple sine relationship calculation and display the unknown angle within display 73.

The manner in which tool 10 may be employed in accordance with the foregoing summary of operation to establish desired angles in a work piece during fabrication is described below in greater detail in FIG. 4.

FIG. 2 sets forth a side elevation view of tool 10 having frame 11 defining a slot 28 therein. It will be recalled that frame 11 further defines an upper edge 18. A pair of fasteners 36 and 37 (fastener 37 seen in FIG. 3) are threadably received within frame 11. Tool 10 further includes a generally planar plate 50 having a lower edge 51 and an upper edge 52. Upper edge 52 is received within slot 28 of frame 11 and is positioned by reference pins 31 and 33 (seen in FIG. 1) with great precision. Fasteners 36 and 37 (fastener 37 seen in FIG. 3) secure plate 50 within slot 28. As is also described above, plate 50 defines a front surface 53 which supports a calculator 54.

Tool 10 further includes a sine bar 12 having an end 16 resting upon edge 18 of frame 11. As is better seen in FIG. 1, sine bar 12 is pivotally secured to frame 11 at a pivot 13. Pivot 13 includes a screw 41 and a plurality of spring washers 42 which permits adjustment of the movement resistance of sine bar 12 with respect to frame 11.

Sine bar 12 further includes a flange 15 which receives a plate 21 of bubble assembly 20. Plate 21 is secured to flange 15 by a plurality of threaded fasteners 25. Bubble assembly unit 20 further includes a riser 22 which, is better seen in FIG. 3, is fabricated in accordance with conventional fabrication techniques and includes a sight glass 23 and a reference mark 24 together with a captivated air bubble 26.

FIG. 3 sets forth a top view of angle measurement tool 10. As described above, tool 10 includes a sine bar 12 secured to a frame 11 by a pivot 13. Pivot 13 includes a screw 41 and a plurality of spring washers 42. As is also described above, sine bar 12 supports a bubble assembly 20 having a plate 21 secured to a sine bar 12 by a plurality of fasteners 25. Bubble assembly 20 further includes a riser 22 supporting a sight glass 23 having a reference mark 24 formed thereon. In accordance with conventional fabrication techniques, riser 22 and sight glass 23 captivate a quantity of appropriate liquid and the captivated air of air bubble 26. A pair of fasteners 36 and 37 are threadably received within frame 11 to secure plate 50 (seen in FIG. 2).

FIG. 4 sets forth a front view of an illustrative example of the use of angle measurement tool 10 in a typical machine or tool shop environment. A vice 85 constructed in accordance with conventional fabrication techniques, secures a typical work piece 81. In the anticipated use of vice 85, the vice supporting work piece 81 is positioned upon a horizontal reference surface such as the table or bed of a machine such as a milling or precision surface grinding machine. Work piece 81 defines a pair of surfaces 82 and 83 which are disposed at some angle therebetween.

FIG. 4 also shows the present invention angle measurement tool positioned upon surface 83. Such that edge 51 is resting upon surface 83. As described above, angle measurement tool includes a frame 11 having a pair of apertures 34 and 35 formed therein. Frame 11 further includes reference pins 31 and 33 and an upper edge 18.

Tool 10 further includes a sine bar 12 pivotally secured to frame 11 by a pivot 13 formed of a fastener 40 and a threaded screw 41 (screw 41 seen in FIG. 2). Sine bar 12 further defines a circular end 16 and a stop limit 17. An angular scale 19 is formed upon sine bar 12 and a cooperating reference mark 27 is formed upon frame 11. The cooperating of reference mark 27 and angle scale 19 facilitates the approximate positioning of sine bar 12 in preparation for angle measurement or setting. Sine bar 12 further includes a flange 15 supporting a plate 21 of a bubble assembly 20. Bubble assembly 20 includes a riser 22 and is secured to flange 15 by a plurality of fasteners 25.

In further accordance with the present invention, angle measurement tool 10 includes a calculator 54 supported upon surface 53 of plate 50.

In the example shown in FIG. 4, a conventional set of calipers 90 are utilized in measuring the distance between edge 18 of frame 11 and circular end 16 which is utilized in the employment of angle measurement tool 10. Thus, calipers 90 are conventional in fabrication and use a pair of inside jaws 92 and 93 as well as a pair of outside jaws 94 and 95. The distance between jaws 92 and 93 is equal to the distance between jaws 94 and 95 and is shown upon dial indicator 91 in further accordance with conventional fabrication techniques. Of importance with respect to the present invention, is the use of a measuring device such as calipers 90 to determine the distance H between edge 18 and circular end 16 of sine bar 12.

As mentioned above, angle measurement tool 10 may be used to facilitate the fabrication of a work piece having a surface formed at a desired angle with reference to another surface upon the work piece or alternatively, may be used to determine or check the angle between two given surfaces on a work piece.

Considering initially the use of angle measurement tool 10 to facilitate the fabrication of a surface 82 upon work piece 81 which defines a predetermined angle with respect to surface 83, angle measurement tool 10 is employed in the manner shown in FIG. 4. The desired angle in the example of FIG. 4, is indicated by angle 100 and involves setting work piece 81 within vice 85 such that surface 83 is positioned at the desired angle relative to the horizontal reference plane. This setting is utilized because the anticipated milling or precision grinding operation to-be-performed upon work piece 11 once the correct position of work piece 81 has been set within vice 85 results in forming surface 82 in a parallel relationship to the horizontal reference plane.

Accordingly, since in this example the angle desired at angle 100 is known, the user employs calculator 54 in the manner shown in FIG. 1 to calculate the distance H between edge 18 and circular end 16 of sine bar 12 which produces the desired angle between sine bar 12 and frame 11 (and more importantly edge 51). As described above, and with temporary return to FIG. 1, the user determines the distance H to be set by simply employing keys 60 through 70 to input the desired angle and thereafter activating command key 72 to cause calculator 54 to display the precise value of the distance H. As mentioned above, calculator 54 utilizes a simple trigonometric sine function to determine this distance since the distance between the center of pivot 13 and circular end 16 has been established and is set within calculator 54.

If for example the desired angle is forty-five degrees, and if tool 10 is fabricated as described above to define a three inch distance between the center of pivot 13 and end 16, then calculator 54 determines H by simply multiplying three times the sine of forty-five degrees. This calculation is straight forward and well within the capabilities of even the most primitive of calculators.

Returning to the example of FIG. 4, upon calculation of the H distance corresponding to the desired angle, the user simply employs calipers 90 to set the desired distance in the manner shown in FIG. 4. Once the desired distance has been established between edge 18 and circular end 16, calipers 90 may be removed and the position of work piece 81 within vice 85 is adjusted until the air bubble within bubble assembly 20 is properly centered within reference mark 24 (seen in FIG. 3). At this point, sine bar 12 is positioned in the horizontal plane and surface 83 is positioned at the desired angle with respect to the horizontal plane. As a result, the milling or surface grinding of work piece 81 upon surface 82 with work piece 81 thus positioned will produce the desired angle between surfaces 82 and 83.

Continuing with the example shown in FIG. 4, angle measurement tool 10 may be used to determine a given angle or check a angle relationship between two surfaces of a work piece such as surfaces 82 and 83. In this converse operation of angle measurement tool 10, sine bar 12 is moved to the fully closed position shown in FIG. 1. Thereafter, tool 10 is rested upon surface 82 along edge 51. The position of work piece 81 within vice 85 is adjusted until surface 82 is shown to be horizontal. With surface 82 positioned in accordance with the horizontal reference plane, the angle between surface 82 and surface 83 may be determined by again positioning angle measurement tool 10 upon surface 83 using edge 51 in the manner illustrated in FIG. 4. Thereafter, while maintaining edge 51 against surface 83, sine bar 12 is pivoted away from frame 11 until bubble assembly 20 indicates the position of air bubble 26 within reference mark 24 (seen in FIG. 3). At this point, the user simply needs to measure the distance between circular end 16 of sine bar 12 and edge 18 of frame 11. This measurement may be carried forward using calipers 90 in the manner shown or alternatively utilizing some other measurement device. The importance aspect with respect to the present invention, is the determination of the distance H existing between circular end 16 of sine bar 12 and edge 18 of frame 11. With this distance known, and returning temporarily to FIG. 1, the user employs numeric input keys 60 through 70 to input the distance H to calculator 54. Thereafter, the user activates command key 71 causing calculator 54 to display the angle (angle 100) existing between sine bar 12 and frame 11. Because surface 82 has been previously positioned in the horizontal reference plane, this angle also corresponds to angle 100 which is the angle between surfaces 82 and 83.

As a result, the present invention angle measurement tool is able to operate quickly and efficiently employing an integrally fabricated calculator and an angle measurement sine bar together with a bubble assembly reference element. The present invention angle measurement tool is readily capable of operation for both fabrication of a work piece having angled surfaces to be formed thereon as well as in the inspection or measurement operations of a given work piece to determine the actual angle between two surfaces thereon.

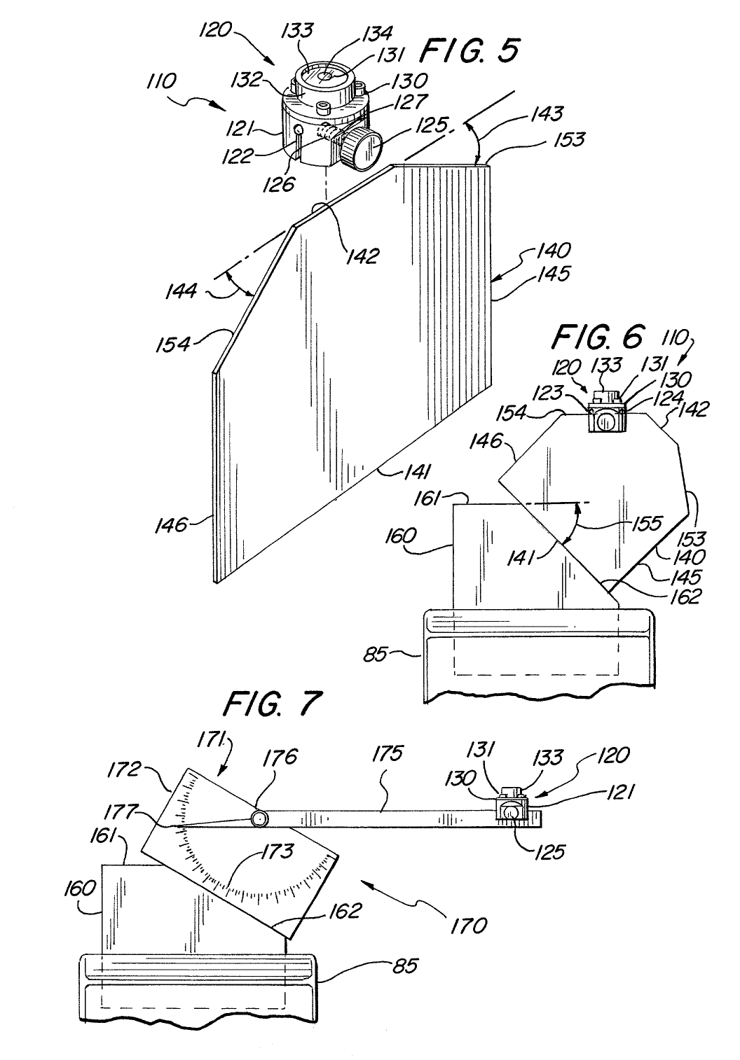

FIG. 5 sets forth a perspective assembly view of an alternate embodiment of the present invention angle measurement tool generally referenced by numeral 110. Angle measurement tool 110 includes an angle plate 140 formed of a rigid material and preferably a high quality steel or the like. Plate 140 defines a lower edge 141 and an upper edge 142 which are precisely parallel. Plate 140 further defines a pair of side edges 145 and 146 which in the preferred fabrication of tool 110 are precisely perpendicular to edges 141 and 142. In further accordance with the present invention, angle plate 140 defines a pair of angled edges 153 and 154. In the preferred fabrication of the present invention, angled edge 153 defines an angle 143 which is equal to thirty degrees while angled edge 154 forms an angle 144 with respect to edge 142 equal to forty-five degrees. However, it will be apparent to those skilled in the art, that while angles thirty degrees and forty-five degrees are convenient standard angles frequently used, angle plate 140 may define virtually any angle which is intended to be used without departing from the spirit and scope of the present invention.

Tool 110 further includes a bubble assembly 120 which includes a housing 121 defining a slot 122 extending therethrough. The upper edge of slot 122 supports a pair of reference balls 123 and 124 (ball 124 seen in FIG. 6). Housing 121 further includes a threaded aperture 127 within which a threaded screw 125 is engaged. Screw 125 defines an internal end 126 which is received within aperture 127 in threaded engagement. It will be understood that aperture 127 extends into slot 122 allowing end 126 to be advanced into slot 122 for reasons set forth below in greater detail.

Bubble assembly 120 further includes a plate 130 secured to housing 121 by a plurality of fasteners 131. Plate 130 further supports a cylindrical riser 132 having a sight glass 133 bearing a reference mark 134 at the center thereof. Glass 133 and riser 132 cooperate to captivate a quantity of liquid therein which in turn forms an air bubble 135.

FIG. 6 sets forth a front view of angle measurement tool 110 in a typical use being employed upon a work piece 160 secured within a conventional vice 85. Work piece 160 defines a pair of surfaces 161 and 162. In the example set forth in FIG. 6, it is desired to form surface 161 so-as-to define an angle of forty-five degrees with surface 162.

Accordingly, angle measurement tool 110 which as described above, includes a plate 140 and a bubble unit 120 is positioned upon surface 162 along edge 141. It will be recalled that plate 140 defines parallel edges 141 and 142 together with angled edges 153 and 154 and perpendicular edges 145 and 146. It will be further recalled that bubble unit 120 defines a slot 122 (seen in FIG. 5) which allows bubble unit 120 to be positioned upon a selected edge such as edge 154 of plate 140. Once bubble unit 120 is positioned upon edge 154 of plate 140, edge 154 contacts reference balls 123 and 124 to precisely position edge 154, housing 121 and riser 132 for accurate angular measurement. Once bubble assembly 120 is properly positioned upon edge 154, screw 125 is turned to force end 126 (seen in FIG. 5) against plate 140 and firmly secure bubble assembly 120. It will be noted that because an angle of forty-five degrees indicated as angle 155 between surfaces 161 and 162 is desired, bubble assembly 120 is placed upon forty-five degree angle edge 154. It will be apparent in the event a thirty-degree angle is desired, bubble unit 120 is positioned upon edge 153 and the positioned of plate 140 is reversed from that shown in FIG. 6. It will be further apparent that a sixty degree angle may be created by placing bubble unit 120 upon edge 153 and placing edge 146 upon surface 162. All of the foregoing variations are made possible by the angular edges provided on plate 140.

Returning to the example of FIG. 6 in which angle 155 is desired to be formed at forty-five degrees with respect to surface 162, the combination of work piece 160 and tool 110 is moved within vice 85 until bubble assembly 120 shows bubble 135 (seen in FIG. 5) centered within reference mark 134. At that point, angle 155 is exactly forty-five degrees with respect to surface 162. Thereafter, vice 85 may be firmly tightened and milling or surface grinding operation carried forward on surface 161 to produce the desired angular relationship between surfaces 161 and 162.

FIG. 7 sets forth a front view of a still further alternate embodiment of the present invention angle measurement tool generally referenced by numeral 170. Tool 170 utilizes a conventional protractor 171 having a plate 172 defining an angular scale 173 formed thereon. Protractor 171 further includes an arm 175 having a pointer 177 pivotally secured at a pivot 176. In the example of FIG. 7, a work piece 160 having angled surfaces 161 and 162 is secured within a conventional vice 85.

In accordance with the present invention, a bubble assembly 120 identical to bubble assembly 20 shown in FIGS. 5 and 6, is supported upon arm 175. As described above, bubble assembly 120 includes a housing 121 defining a slot 122 (seen in FIG. 5). Housing 121 further supports a screw 125 and a plate 130 secured by fasteners 131. Plate 130 in turn supports a cylindrical riser 132 which, as is better seen in FIG. 5, supports a sight glass 133 having a reference 134 formed thereon.

In operation, the positioning of bubble assembly 120 upon arm 175 allows protractor 171 to be provided with a convenient horizontal reference apparatus. Thus, with plate 172 resting upon surface 162, the angle between surfaces 161 and 162 to be formed in the surface grinding or milling process may be measured by simply positioning arm 175 until bubble assembly 120 indicates arm 175 is positioned in the horizontal reference plane. Thereafter, the indication given by pointer 177 along scale 173 indicates the angle which will be formed between surfaces 161 and 162 following the horizontal surface grinding or milling operation. It will be apparent to those skilled in the art that the converse operation may be carried forward by positioning arm 175 upon surface 161 and using bubble assembly 120 to position surface 161 in the horizontal plane. Thereafter, repositioning protractor 171 as shown in FIG. 5, allows movement of arm 175 to the horizontal plane and thereby produces measurement of the actual angle between surface 162 and surface 161.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. An angle measurement tool comprising:
a frame;
a sine bar having first and second ends;
a pivot pivotally joining said one end of said sine bar to said frame, said sine bar pivotable with respect to said frame;
a plate secured to said frame and defining a front surface and a lower edge; and
a bubble assembly secured to said sine bar having a liquid and glass bubble level indicator.

2. The angle measurement tool set forth in claim 1 wherein said plate and said frame are separate parts and wherein said frame defines a slot for receiving a portion of said plate.

3. The angle measurement tool set forth in claim 2 wherein said second end defines a generally rounded shape.

4. The angle measurement tool set forth in claim 3 wherein said frame defines an upper edge generally parallel to said lower edge of said plate and wherein said sine bar pivots between a closed position in which said second end of said sine bar touches said upper edge and an open position to define and angle between said lower edge of said plate and said sine bar.

5. The angle measurement tool set forth in claim 4 further including a calculator supported upon said front surface of said plate.

6. The angle measurement tool set forth in claim 1 further including a calculator supported upon said front surface of said plate.

7. An angle measurement tool comprising:
a plate defining a plurality of edges;
a bubble assembly having means for attachment to said plate along a selected on of said edges, said bubble assembly having a liquid and a glass bubble level indicator; and
means for precisely positioning said bubble assembly upon said selected edge such that the level indicator of said bubble assembly indicates a horizontal alignment when said selected edge is in a horizontal plane.
